(19) United States
(12) Patent Application Publication
(10) Pub. No.: US 2026/0134750 A1
(43) Pub. Date: May 14, 2026

(54) GAME SYSTEM AND PRIZE ACQUISITION GAME DEVICE

(71) Applicant: SEGA CORPORATION, Tokyo (JP)

(72) Inventors: Takaya Goshozono, Tokyo (JP); Mitsuharu Fukazawa, Tokyo (JP); Naoaki Shoui, Tokyo (JP); Taro Tamukai, Tokyo (JP); Ayumi Goto, Tokyo (JP); Tamotsu Ishii, Tokyo (JP); Masaya Nakano, Tokyo (JP); Takayoshi Suzuki, Tokyo (JP)

(73) Assignee: SEGA CORPORATION, Tokyo (JP)

(21) Appl. No.: 19/443,349

(22) Filed: Jan. 8, 2026

Related U.S. Application Data
(63) Continuation of application No. PCT/JP2024/007102, filed on Feb. 27, 2024.

(30) Foreign Application Priority Data
Jul. 10, 2023 (JP) 2023-113370

(51) Int. Cl. G07F 17/32

(52) U.S. Cl. CPC G07F 17/3227; G07F 17/3211; G07F 17/3297

(57) ABSTRACT

A game system includes: a player terminal operated by a player; a prize acquisition game device that comprises a prize catcher equipped with an arm, inside a prize housing that houses a prize for a prize acquisition game; and a server device that communicates with the player terminal and the prize acquisition game device via a network. The server device registers, in association with the player, a setting content that relates to the prize acquisition game device and has been determined by an operation of the player, and links the player to the prize acquisition game device on which the player plays the prize acquisition game. The prize acquisition game device obtains the setting content registered in association with the linked player, and advances the prize acquisition game played by the player by reflecting the setting content in the prize acquisition game.

### BACKGROUND

### Technical Field

The present invention relates to a game system and a prize acquisition game device.

### Description of Related Art

A prize acquisition game device provided with a setting operation unit that sets various setting contents relating to the prize acquisition game device by an administrator (for example, a staff member of an amusement facility, or the like) is known (for example, patent document 1).

### Patent Documents

[Patent Document 1] JP 2015-226627 A

### Technological Problem to Be Solved by Invention

The administrator can change various setting contents (for example, prize acquisition operation, image, audio, and the like) relating to the prize acquisition game device in accordance with the kind, size, shape, and the like of the prize. However, the player cannot independently change setting contents relating to the prize acquisition game device simply by playing the prize acquisition game.

### SUMMARY

One or more embodiments of the present invention provide a game system and a prize acquisition game device that enable a player to change setting contents relating to the prize acquisition game device.

According to one aspect of the present invention, a game system comprises: a player terminal operated by a player; a prize acquisition game device that comprises a prize catcher equipped with an arm, inside a prize housing that houses a prize for a prize acquisition game; and a server device that communicates with the player terminal and the prize acquisition game device via a network,
wherein the server device comprises a central processing unit (CPU) that:
in response to a request from the player terminal, registers, in association with the player, a setting content that relates to the prize acquisition game device and has been determined by an operation of the player, and
in response to a request from the player terminal, links the player to the prize acquisition game device on which the player plays the prize acquisition game, and
wherein the prize acquisition game device comprises a central processing unit (CPU) that obtains, from the server device, the setting content registered in association with the linked player, and advances the prize acquisition game played by the player by reflecting the setting content in the prize acquisition game.

Other features of one or more embodiments of the present invention will become apparent in light of the Specification of the present invention and the accompanying Drawings.

### BRIEF DESCRIPTION OF DRAWINGS

FIG. 1 is a configuration diagram illustrating one example of a game system 1 according to one or more embodiments.

FIG. 2 is a block diagram illustrating a functional configuration of a player terminal 10 according to one or more embodiments.

FIG. 3 is a block diagram illustrating a functional configuration of a server device 20 according to one or more embodiments.

FIG. 4 is a configuration diagram illustrating one example of player information according to one or more embodiments.

FIG. 5 is a configuration diagram illustrating one example of prize information according to one or more embodiments.

FIG. 6 is a configuration diagram illustrating one example of facility information according to one or more embodiments.

FIG. 7 is a configuration diagram illustrating one example of game device information according to one or more embodiments.

FIG. 8 is a configuration diagram illustrating one example of player linkage information according to one or more embodiments.

FIG. 9 is an external view illustrating a configuration of a prize acquisition game device 50 according to one or more embodiments.

FIG. 10 is a block diagram illustrating a functional configuration of the prize acquisition game device 50 according to one or more embodiments.

FIG. 11 is a configuration diagram illustrating one example of setting type information according to one or more embodiments.

FIG. 12 is a visualization illustrating one example of a setting screen 500 of the prize acquisition game device 50 according to one or more embodiments.

FIG. 13 is a visualization illustrating another example of the setting screen 500 of the prize acquisition game device 50 according to one or more embodiments.

FIG. 14 is a flowchart for describing an operation example relating to pre-registration of setting contents determined by a player, according to one or more embodiments.

FIG. 15 is a visualization illustrating one example of a setting screen 600 of the player terminal 10 according to one or more embodiments.

FIG. 16 is an image diagram illustrating one example of a setting screen 650 of the player terminal in one or more embodiments.

FIG. 17 is a flowchart for describing an operation example relating to linking to the prize acquisition game device 50 according to one or more embodiments.

FIG. 18A and FIG. 18B are visualization illustrating one example of an initial screen 700 in one or more embodiments.

FIG. 19 is a visualization illustrating one example of a payment method selection screen 800 in one or more embodiments.

FIG. 20 is a visualization illustrating one example of a spectacle screen 900 in one or more embodiments.

### DETAILED DESCRIPTION OF EMBODIMENTS

At least the following will become apparent in light the description of the present Specification and the accompanying Drawings.

Namely, this is a game system comprising: a player terminal operated by a player; a prize acquisition game device that comprises a prize catcher equipped with an arm, inside a prize housing that houses a prize for a prize acquisition game; and a server device that communicates with the player terminal and the prize acquisition game device via a network,
wherein the server device comprises a central processing unit (CPU) that:
   in response to a request from the player terminal, registers, in association with the player, a setting content that relates to the prize acquisition game device and has been determined by an operation of the player, and
   in response to a request from the player terminal, links the player to the prize acquisition game device on which the player plays the prize acquisition game, and
wherein the prize acquisition game device comprises a central processing unit (CPU) that obtains, from the server device, the setting content registered in association with the linked player, and advances the prize acquisition game played by the player by reflecting the setting content in the prize acquisition game.

According to such a game system, a player controls a player terminal to determine the setting content relating to the prize acquisition game device and registers the setting content to the server device in advance, whereby, when the player plays the prize acquisition game on the linked prize acquisition game device, the linked prize acquisition game device acquires the setting content registered in advance from the server device and reflects them in the prize acquisition game. Thus, the player can independently change the setting content relating to the prize acquisition game device.

Furthermore, this game system may be configured such that the prize acquisition game device further comprises a display device that displays an image, the setting content registered in association with the player includes a setting content relating to the image, and the CPU of the prize acquisition game device reflects the setting content relating to the image at any timing that does not interfere with the prize acquisition game played by the player.

According to such a game system, a player controls a player terminal to determine the setting content relating to the image in the prize acquisition game device and registers the setting content to the server device in advance, whereby, when the player plays the prize acquisition game on the linked prize acquisition game device, the linked prize acquisition game device acquires the setting content relating to the image, registered in advance from the server device, and reflects them in the imaged displayed by the display device.

Also, when the player is engrossed in playing the prize acquisition game, the player's sight is intently directed toward a desired prize, and thus the player would not be able to look at the image displayed by the display unit. In contrast to this, in this game system, the setting content relating to the image registered in advance is reflected in the image displayed by the display unit at any timing that does not interfere with the prize acquisition game played by the player. Thus, it is possible to reliably show to the player the image in which the setting content registered in advance relating to the image is reflected.

Furthermore, this game system may be configured such that the prize acquisition game device comprise an audio output device that outputs audio, the setting content registered in association with the player includes a setting content relating to the audio, and the CPU reflects the setting content relating to the audio output by the audio output device at any timing during the prize acquisition game by the player.

According to such a game system, a player controls a player terminal to determine the setting content relating to audio in the prize acquisition game device and registers the setting content to the server device in advance, whereby, when the player plays the prize acquisition game on the linked prize acquisition game device, the linked prize acquisition game device acquires the setting content relating to the audio, registered in advance from the server device, and reflects them in audio output by the audio output device.

The player who is engrossed in playing the prize acquisition game can listen to the audio without hindrance to play even when the player's sight is intently directed toward the desired prize. Therefore, in this game system, the setting content relating to the audio registered in advance is reflected in the audio output by the audio output device during play of the prize acquisition game.

Furthermore, this game system may be configured such that the setting content registered in association with the player includes a setting content relating to an opening and closing operation of the arm, and the CPU of the prize acquisition game device reflects the setting content relating to the opening and closing operation of the arm in the opening and closing operation of the arm performed by the prize catcher at a time when the player starts playing the prize acquisition game.

According to such a game system, a player controls the player terminal to determine the setting content relating to the arm opening and closing operation in the prize acquisition game device and registers the setting content to the server device in advance, whereby, when the player plays the prize acquisition game on the linked prize acquisition game device, the linked prize acquisition game device acquires the setting content relating to the arm opening and closing operation, registered in advance from the server device, and reflects them the arm opening and closing operation performed by the prize catcher.

Furthermore, this game system may be configured such that the CPU of the server device registers, in association with the player, a setting content associated with a character selected by an operation of the player from among a plurality of types of characters each associated with the setting content of the prize acquisition game device, and the CPU of the prize acquisition game device acquires from the server device the setting content associated with the character registered in association with the linked player, and advances the prize acquisition game played by the player by reflecting the setting content in the prize acquisition game.

According to such a game system, the player can register in advance the setting content associated with the selected character in the server device simply by operating the player terminal and selecting any character from among a plurality of kinds of characters. That is, even a player who cannot decide how to determine the setting content relating to the prize acquisition game device can easily register the setting content in advance simply by selecting any character.

Furthermore, this game system may be configured such that the setting content associated with each of the types of characters is different for each character and includes at least a setting content relating to an image associated with each character and a setting content related to audio associated with each character, the prize acquisition game device further comprises a display device that displays an image and an audio output device that outputs audio, and the CPU of the prize acquisition game device acquires from the server device the setting content associated with the character registered in association with the linked player, reflects the setting content relating to the image associated with the character in the image displayed by the display device at any timing that does not interfere with the prize acquisition game played by the player, and reflects the setting content relating to the audio associated with the character in the audio output by the audio output device at any timing during the prize acquisition game by the player.

According to such a game system, the setting content relating to audio and the setting content relating to images in the prize acquisition game device are different for each character, and thus the player can change the setting content relating to the prize acquisition game device while enjoying character selection. Moreover, the player can register in advance a plurality of types of setting items (both the setting content relating to the audio and the setting content relating to images in the prize acquisition game device) simply by selecting the character.

Next there is prize acquisition game device that communicates via a network with a server device that can be accessed by a player terminal operated by the player, the prize acquisition game device comprising: a prize catcher equipped with an arm, inside a prize housing that houses a prize for a prize acquisition game; and central processing unit (CPU), wherein the server device: registers, in response to a request from the player terminal, a setting content that relates to the prize acquisition game device and has been determined by the player, in association with the player, and links, in response to a request from the player terminal, the player with the prize acquisition game device on which the player plays the prize acquisition game, and the CPU of the prize acquisition game device acquires the setting content registered in association with the linked player from the server device, and advances the prize acquisition game played by the player by reflecting the setting contents in the prize acquisition game.

According to such a prize acquisition game device, the player can independently change the setting contents relating to the prize acquisition game device.

### Embodiments

In the following embodiments, a detailed description will be given by using a game system using a prize acquisition game device installed in a usage facility (for example, an amusement facility) as an example.

### <<Configuration of Game System 1>>

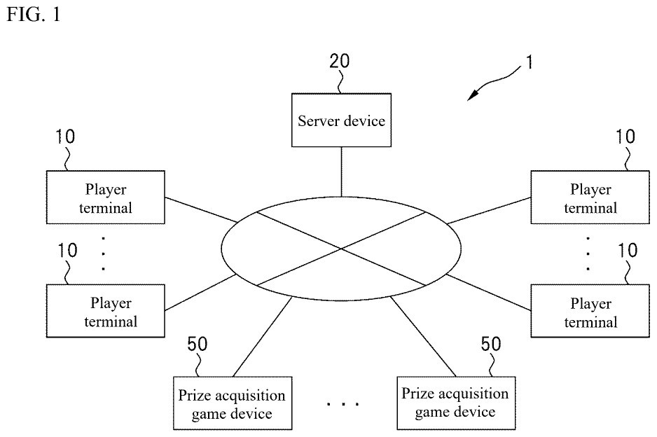

FIG. 1 is a configuration diagram illustrating one example of a game system 1 according to one or more embodiments. In the game system 1 according to one or more embodiments, a player having entered an amusement facility can play a prize acquisition game by using a prize acquisition game device in the facility. An administrator (for example, facility staff) of the amusement facility can set various setting contents relating to the prize acquisition game device by using the prize acquisition game device in the facility.

The game system 1 according to one or more embodiments has a server device 20, a player terminal 10 used by the player, and a prize acquisition game device (or prize acquisition game machine) 50 used by the player and the administrator, as illustrated in FIG. 1.

The player terminal 10 is a terminal device having a function of a digital camera such as a smartphone (hereinafter referred to simply as “camera”) and is connected to the server device 20 via a network so as to be able to communicate information.

Before playing the prize acquisition game of the prize acquisition game device 50, the player can using the player terminal 10 to set various setting contents on the prize acquisition game device 50. When accessed by the player terminal 10 via the network, the server device 20 can preliminarily register setting contents relating to the prize acquisition game device 50 determined by the player of the player terminal 10.

The prize acquisition game device 50 is a commercial game device installed in an amusement facility and is connected to the server device 20 via a network so as to be capable of information communication. The prize acquisition game device 50 has an identification code (for example, a two-dimensional code) which the player terminal 10 can scan by the camera function.

The server device 20 functions to, when the player terminal 10 having scanned the identification code of the prize acquisition game device 50 gains access via the network, link the player of the player terminal 10 to the prize acquisition game device 50 by pairing the player of the player terminal 10 in association with the prize acquisition game device 50.

When setting contents relating to the prize acquisition game device 50 that have been registered in advance by the linked player are acquired from the server device via the network, the prize acquisition game device 50 can reflect the setting contents in the prize acquisition game played by the player.

Note that the game system 1 in FIG. 1 is one example, and it goes without saying that various other system configuration examples are possible depending on the application and purpose. For example, the server device 20 in FIG. 1 may be distributed across a plurality of computers. The server device 20 may handle some functions of the player terminal 10, or the player terminal 10 may handle some functions of the server device 20. Furthermore, the server device 20 may be installed in an amusement facility.

Moreover, the prize acquisition game device 50 may be connected to the server device 20 (external server) via a relay device (internal server) installed in the same amusement facility. The relay device acts as a relay between the server device 20 and the prize acquisition game device 50 to transmit and receive various information and is a device which handles some functions of the server device 20. That is, the relay device is not only connected to the server device 20 via a communication network, but is also connected to the prize acquisition game device 50 installed in the same amusement facility via the communication network. In this case, the server device 20 may handle some functions of the relay device.

### <<Configuration of Player Terminal 10>>

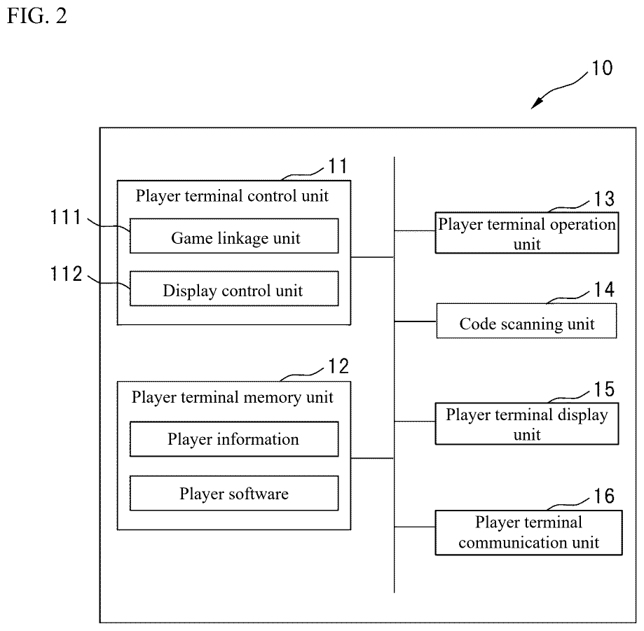

FIG. 2 is a block diagram illustrating a functional configuration of a player terminal 10 according to one or more embodiments. The player terminal 10 is an information processing device (for example, a smartphone, a tablet terminal, a mobile telephone terminal, or the like) that each player can own and use.

The player terminal 10 according to one or more embodiments has a player terminal control unit (or player terminal controller) 11, a player terminal memory unit (or player terminal memory) 12, a player terminal operation unit (or player terminal operation device) 13, a code scanning unit (or code scanning device) 14, a player terminal display unit (or player terminal display device) 15, and a player terminal communication unit (or player terminal communication interface) 16, as illustrated in FIG. 2.

The player terminal control unit 11 controls the entirety of the player terminal 10 and is realized by using a CPU (Central Processing Unit) to execute a predetermined program stored in memory. The player terminal control unit 11 in one or more embodiments has a game linkage unit 111 and a display control unit 112.

The game linkage unit 111 controls linking between the player of the player terminal 10 and the prize acquisition game device 50. The display control unit 112 controls screen display of the player terminal 10 according to a procedure relating to the linking between the player of the player terminal 10 and the prize acquisition game device 50.

The player terminal memory unit 12 has a ROM (Read Only Memory), which is a read-only storage area in which various applications and various information required in the player terminal 10 are stored, and a RAM (Random Access Memory), which is a rewritable storage area used as a work area of computation by a player terminal control unit 11, and is realized by a non-volatile storage device, for example, a flash memory, a hard disk, or the like.

The player terminal memory unit 12 in one or more embodiments stores player-specific player software, player information in which a player ID and the like for identifying the player having the player terminal 10, and the like are set. The player software is a program for providing various services to the player by linking to the prize acquisition game device.

The player terminal operation unit 13 has a touch panel for receiving operation input of the player. The player terminal operation unit 13 in one or more embodiments can accept operations particular to a touch panel, such as a tap operation, a swipe operation, and a flick operation.

The code scanning unit 14 controls scanning of an identification code of the prize acquisition game device 50. The code scanning unit 14 in one or more embodiments scans an image of a two-dimensional code as one example of an identification code by a camera function of a player terminal 10 and extracts details of the code.

The player terminal display unit 15 is for displaying an image or the like relating to the linking to the prize acquisition game device 50 on the screen in accordance with the progress of the player software based on instructions from the player terminal control unit 11 and, for example, is realized by a liquid crystal display or the like.

The player terminal communication unit 16 is for performing communication with the server device 20, functions as a receiving unit for receiving various data and signals transmitted from the server device 20, and functions as a transmitting unit for transmitting various data and signals to the server device 20 according to instructions of the player terminal control unit 11.

### <<Configuration of Server Device 20>>

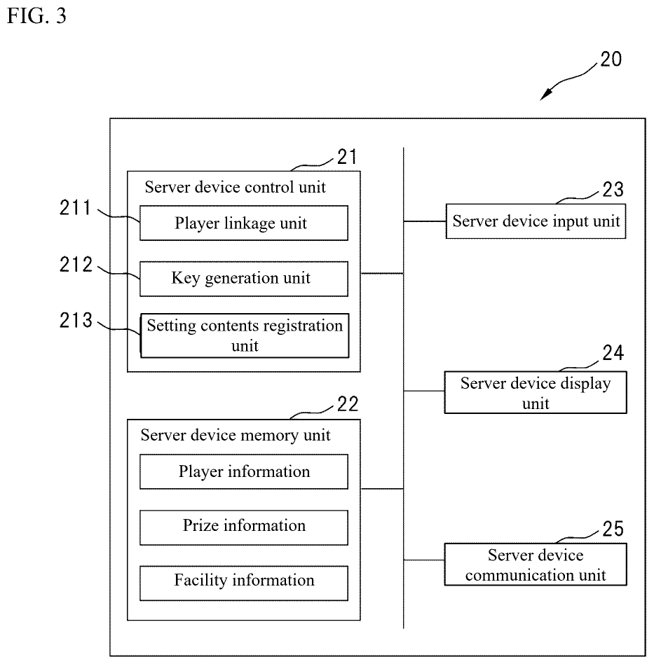

FIG. 3 is a block diagram illustrating a functional configuration of the server device 20 according to one or more embodiments. The server device 20 is an information processing device (for example, a workstation, a personal computer, or the like) used by a system operator for managing various services relating to a prize acquisition game.

The server device 20 in one or more embodiments has a server device control unit (or server device controller) 21, a server device memory unit (or server device memory) 22, a server device input unit (or server device input device) 23, a server device display unit (or server device display device) 24, and a server device communication unit (or server device communication interface) 25, as illustrated in FIG. 3.

The server device control unit 21 performs control of the entire server device 20 and is realized by the CPU executing a predetermined program stored in memory. The server device control unit 21 in one or more embodiments has a player linkage unit 211, a key generation unit 212, and a setting contents registration unit 213.

Upon the player terminal 10 scanning the identification of the prize acquisition game device 50 on which the player will play the prize acquisition game, the player linkage unit 211, in response to a request from the player terminal 10, performs control to linking the prize acquisition game device 50 and the player.

The key generation unit 212 generates a key code included in the identification code of the prize acquisition game device 50. The key generation unit 212 in one or more embodiments generates (issues) a key code periodically (for example, at a frequency of about once an hour) and transmits it to the prize acquisition game device 50.

When the player operates the player terminal 10 to determine setting contents relating to the prize acquisition game device 50, in response to a request from the player terminal 10, the setting contents registration unit 213 registers setting contents relating to the prize acquisition game device 50 determined by an operation of the player in association with the player.

The server device memory unit 22 has a ROM, which is a read-only storage area in which a system program is stored, and a RAM, which is a rewritable storage area used as a work area of computation by a server device control unit 21, and is realized, for example, by a non-volatile storage device such as a flash memory or a hard disk.

The server device memory unit 22 in one or more embodiments stores player information, which is information relating to the player using the player terminal 10, prize information relating to a prize, and facility information, which is information relating to the amusement facility in which the prize acquisition game device 50 is installed.

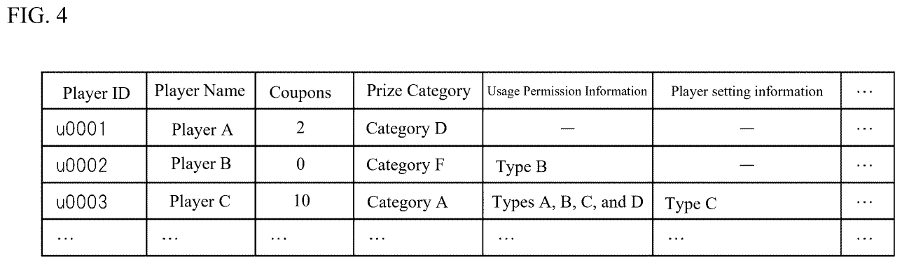

FIG. 4 is a configuration diagram illustrating one example of player information according to one or more embodiments. The player information illustrated in FIG. 4 has as items a player ID, a player name, a coupon, a prize category, usage permission information, player setting information, and the like.

The player ID is information for uniquely identifying the player. Note that identification information unique to the terminal (terminal ID), such as the MAC address of the player terminal 10 possessed by the player, may be used as the player ID. The player name is information indicating a name of the player. The coupon is information indicating a quantity of coupons possessed by the player. The prize category is information indicating a favorite prize category designated by the player independently.

The availability information is information that, among the setting contents relating to the prize acquisition game device 50, indicates setting contents in which use thereof is permitted for the player. In one or more embodiments, the setting contents are classified into four types, and setting patterns differ by type. Here, among the four types, types whose use is permitted for the player are registered as availability information. Note that the types are not limited to four.

The player must purchase usage rights for each type in order to be permitted to use the setting contents for each type. In one or more embodiments, purchasing of each type of usage rights may be realized by purchasing respective characters associated with each type.

The player setting information is information indicating the setting contents relating to the prize acquisition game device 50 determined by the player by operating the player terminal 10. Here, among the types the player is permitted to use by the availability information, one type selected by the player by operating the player terminal 10 is registered as the player setting information.

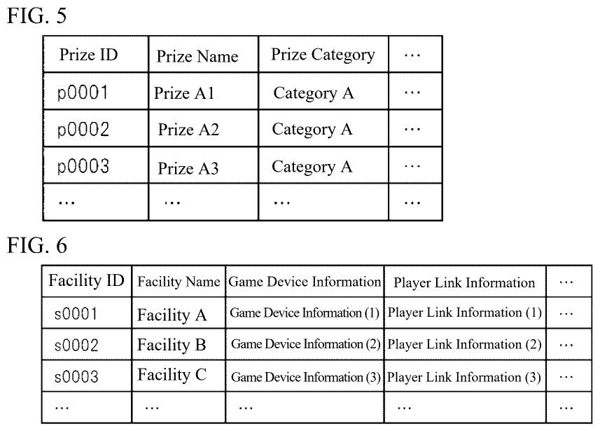

FIG. 5 is a configuration diagram illustrating one example of prize information according to one or more embodiments. The facility information illustrated in FIG. 5 has as items a prize ID, a prize name, a prize category, and the like. The prize ID is information for uniquely identifying the prize. The prize ID may be printed as a code (bar code, two-dimensional code, or the like) on a tag made of paper or resin attached to the prize or written as identification data on an IC tag. The prize name is information indicating a name of the prize. The prize category is information indicating a category to which the prize belongs.

FIG. 6 is a configuration diagram illustrating one example of facility information according to one or more embodiments. The facility information illustrated in FIG. 6 includes as items a facility ID, a facility name, game device information, player linkage information, and the like.

The facility ID is information for uniquely identifying an amusement facility. The facility name is information indicating a name of the amusement facility. The game device information is information relating to the prize acquisition game device 50 installed in the amusement facility. The player linkage information is information relating to the linked player in the amusement facility.

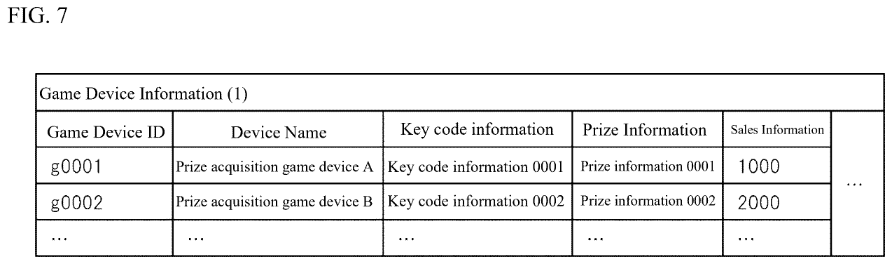

FIG. 7 is a configuration diagram illustrating one example of game device information according to one or more embodiments. The game device information illustrated in FIG. 7 has as items a game device ID, a device name, key code information, prize information, sales information, and the like.

The game device ID is information for uniquely identifying the prize acquisition game device 50 installed in the amusement facility. The device name is information indicating a name of the prize acquisition game device 50. The key code information is information relating to a key code issued to the prize acquisition game device 50, and the key code is set in association with each issuance time (generation time).

The prize information is information indicating a prize that can be obtained in the prize acquisition game device 50 at the present time. A prize ID of a prize which can be acquired is registered in the prize information association with the game device ID of the prize acquisition game device 50. The sales information is information indicating an amount of money inserted into the prize acquisition game device 50 up to the present time.

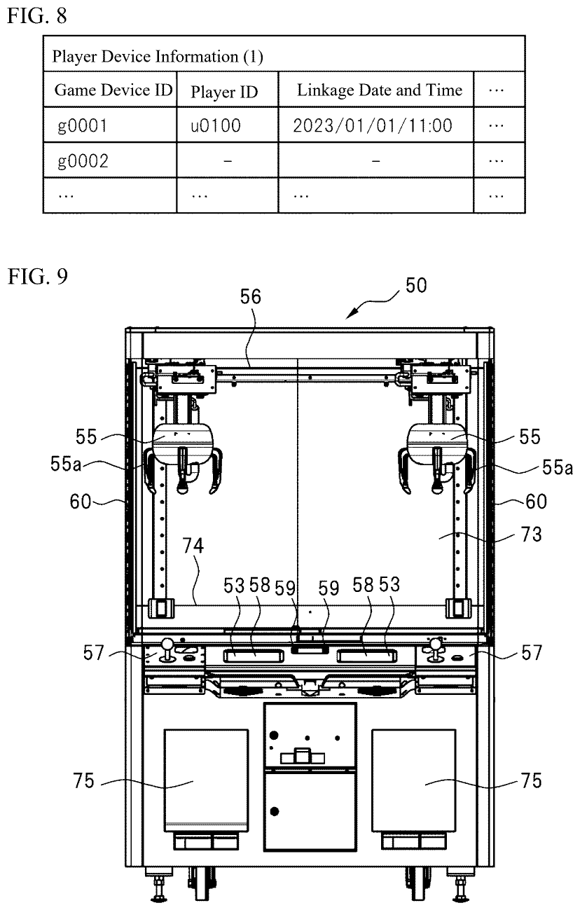

FIG. 8 is a configuration diagram illustrating one example of player linkage information according to one or more embodiments. The player linkage information illustrated in FIG. 8 has as items a game device ID associated with the linked prize acquisition game device 50, a player ID associated with the linked player, a link date and time when the link was completed, and the like.

The server device input unit 23 is for a system administrator or the like to input various data and is realized, for example, by a keyboard, a mouse, or the like. Note that the server device input unit 23 may be configured such that connection is possible as needed.

The server device display unit 24 displays an operation screen for the system administrator based on instructions from the server device control unit 21 and may be realized by, for example, a liquid crystal display (LCD: Liquid Crystal Display) or the like. Note that the server device input unit 23 may be configured such that connection is possible as needed.

The server device communication unit 25 is for performing communication between the prize acquisition game device 50 installed in the amusement facility and the player terminal 10, functions as a receiving unit that receives various data and signals transmitted from the prize acquisition game device 50 and the player terminal 10, and functions as a transmitting unit that transmits various data and signals to the prize acquisition game device 50 and the player terminal 10 in response to instructions from the server device control unit 21.

### <<Configuration of Prize Acquisition Game Device 50>>

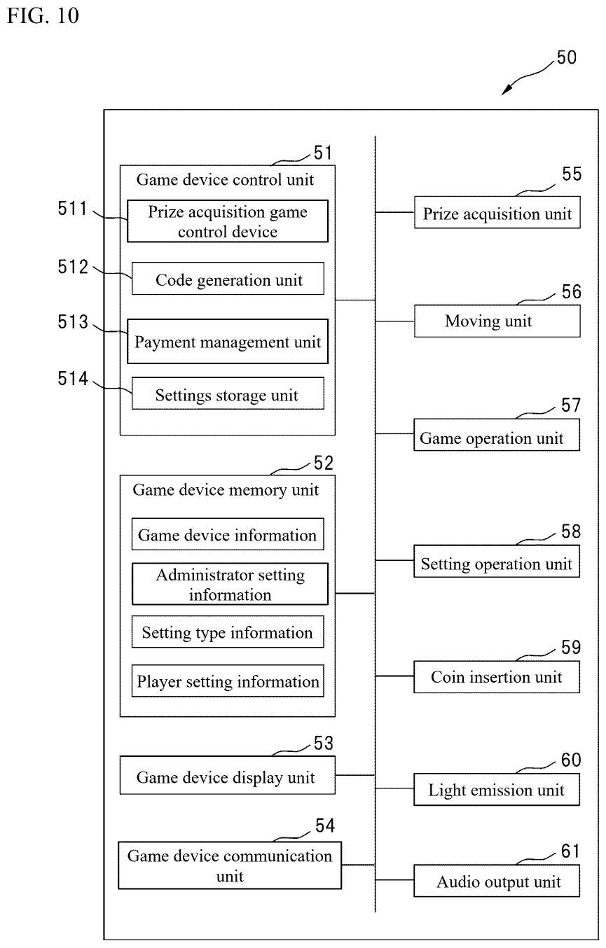

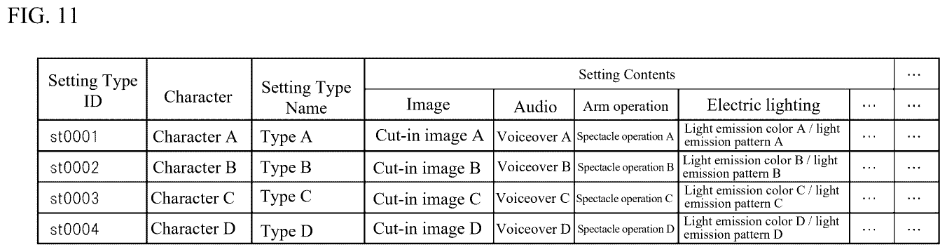

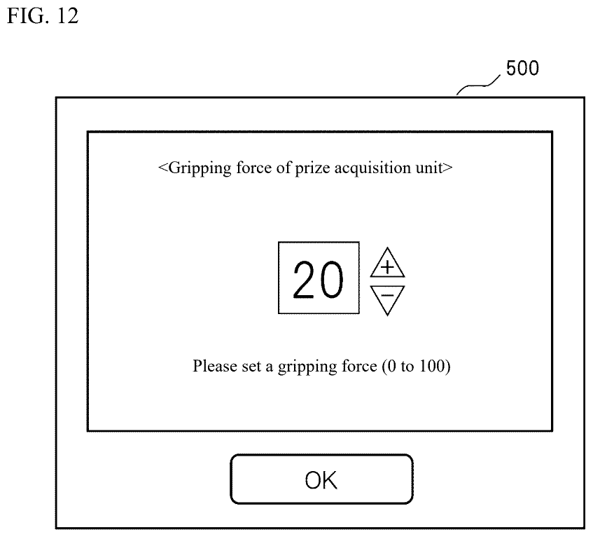

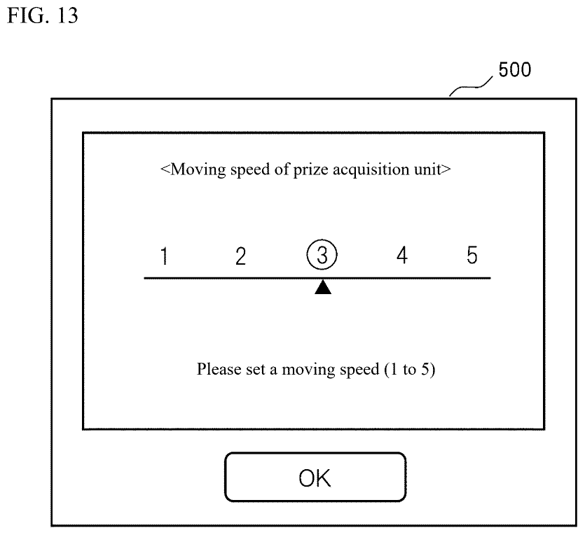

A configuration of the prize acquisition game device 50 according to one or more embodiments will be described using FIG. 9 to FIG. 13. FIG. 9 is an external view illustrating a configuration of the prize acquisition game device 50 according to one or more embodiments. FIG. 10 is a block diagram illustrating a functional configuration of the prize acquisition game device 50 according to one or more embodiments. FIG. 11 is a configuration diagram illustrating one example of setting type information according to one or more embodiments. FIG. 12 is a visualization illustrating one example of a setting screen 500 of the prize acquisition game device 50 according to one or more embodiments. FIG. 13 is a visualization illustrating another example of a setting screen 500 of the prize acquisition game device 50 according to one or more embodiments.

The prize acquisition game device 50 in one or more embodiments has a game device control unit (or game device controller) 51, a game device memory unit (or game device memory) 52, a game device display unit (or game device display device) 53, and a game device communication unit (or game device communication interface) 54, a prize acquisition unit (or prize catcher) 55, a moving unit (or motor driver) 56, a game operation unit (or game operation input device) 57, a setting operation unit (or setting operation panel) 58, a coin insertion unit (or coin insertion device) 59, and a light emission unit (or illumination body) 60, an audio output unit (audio output device) 61, a prize housing unit (or prize housing) 73, a prize presentation unit (or prize presentation base) 74, and a prize retrieval port 75, as illustrated in FIG. 9 and FIG. 10.

The game device control unit 51 controls the entire prize acquisition game device 50 and is realized by the CPU executing a predetermined program stored in memory. A game device control unit 51 in one or more embodiments has a prize acquisition game control unit 511, a code generation unit 512, a payment management unit 513, and a setting storage unit 514, as illustrated in FIG. 10.

The prize acquisition game control unit 511 is one example of a game control unit and performs various controls relating to the prize acquisition game. The prize acquisition game control unit 511 in one or more embodiments advances a prize acquisition game by operating the prize acquisition unit 55, the moving unit 56, or the like based on game operations of the player.

Furthermore, the prize acquisition game control unit 511 in one or more embodiments advances the prize acquisition game played by the player by reflecting setting contents such as a gripping force of the prize acquisition unit 55 and a moving speed of the moving unit 56 determined by operations of the administrator.

Furthermore, in one or more embodiments, when acquiring from the server device 20 setting contents relating to the prize acquisition game device 50 that were registered in advance by the player, the prize acquisition game control unit 511 advances the prize acquisition game by reflecting the setting contents in the prize acquisition game played by the player.

The code generation unit 512 controls generation of the identification code associated with the prize acquisition game device 50. As one example of the identification code, the code generation unit 512 in one or more embodiments generates a two-dimensional code including a most recent key code received from the server device 20 and the game device ID of the prize acquisition game device.

The payment management unit 513 manages for the player payment of a price for playing the prize acquisition game. The payment management unit 513 in one or more embodiments manages whether the payment of a price for one round of play set in advance in the prize acquisition game device 50 is completed by an operation of the administrator, according to a detection signal for detecting payment of a play fee from the coin insertion unit 59 being received.

The setting storage unit 514 performs control for storing setting contents relating to the prize acquisition game in a memory unit 120. The setting storage unit 514 in one or more embodiments stores, as administrator setting information, setting contents (setting contents such as a gripping force of the prize acquisition unit 55 or a moving speed of the moving unit 56) relating to a prize acquisition game device 50 determined by an operation of an administrator. Furthermore, the setting contents relating to the prize acquisition game device 50 received from the server device 20 via the network and determined by an operation of the player are stored as player setting information.

The game device memory unit 52 has a ROM, which is a read-only storage region where various programs and various information relating to the prize acquisition game are stored, and a RAM, which is a rewritable storage region used as a work region of the computation by the game device control unit 51, and is realized by, for example, a non-volatile storage device such as a flash memory or a hard disk.

The game device memory unit 52 in one or more embodiments stores, for example, in addition to the game program and the setting program, game device information (such as the game device ID of the prize acquisition game device 50), administrator setting information (setting contents relating to the prize acquisition game device 50 determined by the administrator at the present time), setting type information, and the like. Furthermore, the player setting information (setting contents relating to the prize acquisition game device 50 determined by the player at the present time) is stored when received from the server device 20 via a network.

The administrator setting information is information indicating setting contents of the prize acquisition game device 50 determined by the administrator operating the prize acquisition game device 50. The setting contents are, for example, a single play fee determined by the administrator, a play limit time, a gripping force and a moving speed of the prize acquisition unit, a light emission color and a light emission pattern of electric lights, and the like.

The setting type information is information indicating setting contents prepared in advance for each type as setting contents which can be determined by the player. Setting contents are classified into four types, and setting patterns differ by type. In one or more embodiments, a plurality of various setting contents are prepared in advance, and thus the player can easily determine the setting contents simply by selecting from among them.

The setting type information according to one or more embodiments has as items a setting type ID, a character, a setting type name, setting contents, and the like, as illustrated in FIG. 11. The setting type ID is information for uniquely identifying the type of setting contents.

The character is a character representing the type of the setting contents so that the player can easily understand such and is information indicating the type of character set corresponding to each type. The setting type name is information indicating a name for distinguishing the type of setting contents. The setting type name may be a name of a character associated with the type.

The setting contents are information indicating a setting pattern formed by combining a plurality of kinds of setting items for each type. The setting contents according to one or more embodiments is, for example, a combination of setting items such as images, audio, arm movements, and electric lights. Note that this combination is one example, and various combinations are possible. Furthermore, such may be formed by one setting item without combining in this manner.

In one or more embodiments, for example, setting contents of “type A” are set as setting contents of a setting item “image” such that when the player gets a prize, for example, a “cut-in image A” (interrupt image) in which a “character A” associated with “type A” appears is displayed on the screen.

Furthermore, for example, when the player gets a prize, “voiceover A” that is a line of “character A” associated with “type A” is set to be output as setting contents of a setting item “audio.”

Moreover, setting contents of a setting item “arm operation” are set so that, for example, when the player starts game operation, an arm is opened and closed by an operation pattern following a “spectacle operation A.”

Furthermore, setting contents of a setting item “electric lights” are set such that, for example, when the player starts a game operation, a light emission unit emits light according to a light emission pattern following “spectacle operation A,” in a “light emission color A” matching a image color of “character A.”

The player setting information is player setting information acquired from the server device 20 and is information indicating setting contents of the prize acquisition game device 50 that were determined by an operation of the player. These setting contents are, for example, a setting type ID of one type selected by the player from among four types, or the like.

The game device display unit 53 is for displaying a setting screen on which the administrator performs a setup operation for changing setting contents of the prize acquisition game device 50 or displaying an image of a two-dimensional code as an identification code associated with the prize acquisition game device 50 and is realized, for example, by a liquid crystal display (LCD: Liquid Crystal Display) or the like.

The game device communication unit 54 is for performing communication with the server device 20, functions as a receiving unit for receiving various data and signals transmitted from the server device 20, and functions as a transmitting unit for transmitting various data and signals to the server device 20 according to instructions of the game device control unit 51.

As illustrated in FIG. 9, the prize housing unit 73 houses one or more prizes inside the prize acquisition game device 50, and a front face and left and right side faces are formed from a transparent material (for example, glass or the like) so that players can see the prizes from the outside. An opening and closing door is provided on the front face of the prize housing unit 73, and an administrator can perform actions such as lining up or restocking prizes. A spatial area enclosed by this prize housing unit 73 is used as a play field for the player to play the prize acquisition game.

As illustrated in FIG. 9, the prize acquisition unit 55 that acquires a prize, the moving unit 56 for moving the prize acquisition unit 55, the prize presentation unit 74 for presenting a prize, and a discharge port (not illustrated) for dispensing a prize acquired by the prize acquisition unit 55 to outside the prize housing unit 73 are disposed inside the prize housing unit 73 in one or more embodiments.

The prize acquisition unit 55 drives an arm opening and closing motor (not illustrated) to acquire a prize housed in the prize housing unit 73 (that is, the prize presented by the presentation unit 74) by an opening and closing operation of a plurality of arms 55a. The moving unit 56 drives a movement motor (not illustrated) to move the prize acquisition unit 55 within the spatial area formed by the prize housing unit 73.

The moving unit 56 in one or more embodiments has a horizontal moving unit, a vertical moving unit, and a raise/lower moving unit. The horizontal moving unit moves the prize acquisition unit 55 in horizontal directions (that is, a forward-backward direction and a left-right direction) in the spatial area formed by the prize housing unit 73. The vertical moving unit moves the prize acquisition unit 55 in a vertical direction (that is, an up-down direction) in the spatial area formed by the prize housing unit 73.

The game operation unit 57 is for the player to perform game operations. The game operation unit 57 in one or more embodiments has at least a joystick and an operation button. When the joystick is operated by the player, it is possible to operate the moving unit 56 to move the prize acquisition unit 55 in the horizontal directions. When the operation button is operated by the player, the moving unit 56 stops, and a position of the prize acquisition unit 55 can be determined in the horizontal directions.

The setting operation unit 58 is used for the administrator to perform a setup operation. The setting operation unit 58 in one or more embodiments is configured from a touch panel and receives input instructions from an operator from a pressed position thereof. The touch panel is stacked on the game device display unit 53, and when a touch operation is performed on the screen, the pressed position (contact position) can be detected based on change in electrostatic capacitance between a fingertip and a conductive film.

The setting storage unit 514 causes the game device display unit 53 to display a setting screen for the administrator to determine setting contents relating to the prize acquisition game device when the administrator performs a predetermined touch operation using the setting operation unit 58.

For example, when the administrator sets the gripping force of the prize acquisition unit 55, the setting storage unit 514 causes the game device display unit 53 to display the setting screen 500 illustrated in FIG. 12. In this setting screen 500, the administrator can set the gripping force of the prize acquisition unit 55 to a desired value in accordance with the kind, size, shape, and the like of the prize.

When the administrator finishes determining the setting contents of the gripping force of the prize acquisition unit 55 and performs a predetermined touch operation using the setting operation unit 58, the administrator can store as administrator setting information the setting contents they determined.

Due to these setting contents being stored, the prize acquisition unit 55 adjusts the gripping force by driving the arm opening and closing motor in accordance with the set desired value.

Furthermore, for example, when the administrator sets the moving speed of the prize acquisition unit 55, the setting storage unit 514 causes the game device display unit 53 to display the setting screen 500 illustrated in FIG. 13. In this setting screen 500, the administrator can set the moving speed of the prize acquisition unit 55 to a desired level in stages in accordance with the kind, size, shape, and the like of the prize.

When the administrator finishes determining the setting contents of the moving speed of the prize acquisition unit 55 and performs a predetermined touch operation using the setting operation unit 58, the administrator can store as administrator setting information the setting contents they determined.

Due to these setting contents being stored, the moving unit 56 adjusts the moving speed by driving the movement motor in accordance with the set desired level (that is, the moving speed of the prize acquisition unit 55 is adjusted).

Furthermore, in one or more embodiments, when a touch operation on the touch panel is performed by the player, an image of the identification code (two-dimensional code) associated with the prize acquisition game device 50 is displayed on the game device display unit 53.

The coin insertion unit 59 is for the player to pay a price for playing the prize acquisition game. The coin insertion unit 59 in one or more embodiments has an insertion port into which a coin (coin) is inserted and a detection sensor for detecting the coin inserted from the insertion port. The player playing the prize acquisition game inputs a predetermined number of coins as a price for one round of play into the insertion port.

As illustrated in FIG. 9, the light emission unit 60 is configured to emit light along column parts on both sides of an opening and closing door 11 and has a plurality of light-emitting diodes. The light-emitting diode is a full-color LED (Light Emitting Diode), and thus the light emission color can be changed.

The light emission unit 60 in one or more embodiments can notify the administrator of an error or the like by emitting light of a light emission color and a light emitting pattern matching setting contents determined by the administrator. Furthermore, the electric lights can be made to shine according to the setting type of the player's preference (in accordance with an image color of a preferred character) by emitting light of a light emission color and a light emitting pattern matching setting contents determined by the player.

The audio output unit 61 amplifies an audio signal (audio information) such as music, audio, or an effect sound, which is output from the game device control unit 51 by a digital amplifier or the like, and outputs the audio signal. For example, this realized by a speaker or the like.

As illustrated in FIG. 9, the prize retrieval port 75 is provided on a front face of the prize acquisition game device 50 and, when a prize acquired by the prize acquisition unit 55 has fallen from the discharge port disposed in the prize housing unit 73, is for the player to retrieve the fallen prize.

### <<Operation of Game System 1>>

An operation example of the game system 1 according to one or more embodiments will be described. Below, operation examples relating to pre-registration of setting contents determined by the player, operation examples relating to linking to the prize acquisition game device 50, operation examples relating to reflection of setting contents determined by the player, and operation examples relating to unlinking from the prize acquisition game device 50 will be described.

### <Pre-Registration of Setting Contents Determined by Player>

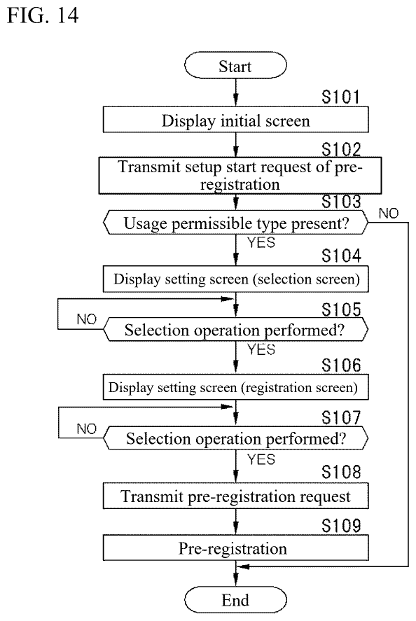

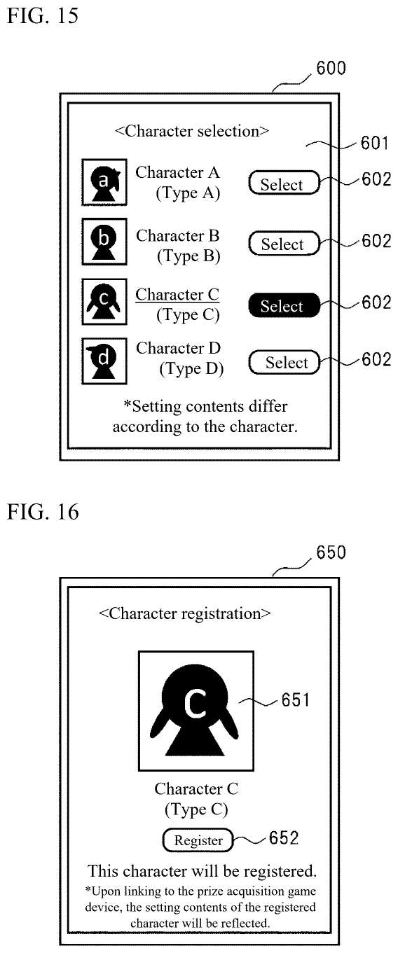

operation examples relating to pre-registration of setting contents decided by the player, according to one or more embodiments, will be described using FIG. 14 to FIG. 16. FIG. 14 is a flowchart for describing an operation example relating to pre-registration of setting contents decided by a player, according to one or more embodiments. FIG. 15 is an image diagram illustrating one example of a setting screen 600 of the player terminal 10 in one or more embodiments. FIG. 16 is an image diagram illustrating one example of a setting screen 650 of the player terminal 10 in one or more embodiments.

As illustrated in FIG. 14, first of all, the display control unit 112 of the player terminal 10 displays an unillustrated initial screen on the player terminal display unit 15 after the player software is started (step S101).

Then, when an item of the pre-registration is selected by an operation of the player on the initial screen (not illustrated), The player terminal 10 transmits the player ID of the player together with a request to start setup of the selected pre-registration to the server device 20 via the network (step S102).

Next, when a request transmitted from the player terminal 10 is received, the setting contents registration unit 213 of the server device 20 references the player information illustrated in FIG. 4 and specifies usage permission information associated with the player ID transmitted from the player terminal 10. Then, with reference to the specified usage permission information, it is determined whether the setting contents of at least one of the four types classified in advance are permitted to be used by the player (step S103).

Then, if it is determined that there is no type whatsoever that the player is permitted to use (step S103: NO), the setting contents registration unit 213 of the server device 20 ends the processing of this flowchart. In contrast to this, if it is determined that there is at least one type that the player is permitted to use (step S103: YES), among the four types classified in advance, the type permitted to the player are specified, and data indicating the specified type is transmitted to the player terminal 10.

Then, the display control unit 112 of the player terminal 10 displays the setting screen 600 of the player terminal 10 illustrated in FIG. 15 on the player terminal display unit 15 based on data received from the server device 20 (step S104).

Specifically, the display control unit 112 of the player terminal 10 references the setting type information illustrated in FIG. 11, specifies the type that the player is permitted to use from among the four types classified in advance based on data received from the server device 20, and obtains a character associated with the specified type. Then, the acquired character is placed in a character placement area 601 included in the setting screen 600 illustrated in FIG. 15 as a selection object of the player.

Next, in the setting screen 600 of the player terminal 10 illustrated in FIG. 15, when the selection button 602 associated with any one of the characters in the character placement area 601 is selected by the player (step S105: YES), the display control unit 112 of the player terminal 10 causes the player terminal display unit 15 to display the setting screen 650 for pre-registering setting contents of the type associated with the selected character (step S106).

Then, in the setting screen 650 of the player terminal 10 illustrated in FIG. 16, When the player selects a registration button 652 for pre-registering in advance the type of the character 651 selected by the player (step S107: YES), the player terminal 10 transmits the player ID of the player and a request for pre-registration of the setting contents of the type associated with the selected character to the server device 20 via the network (step S108).

Next, when the request transmitted from the player terminal 10 is received, the setting contents registration unit 213 of the server device 20 references the player information illustrated in FIG. 4, specifies player setting information associated with the player ID transmitted from the player terminal 10, and registers the type associated with the character selected by the player (step S109).

### <Linking to Prize Acquisition Game Device 50>

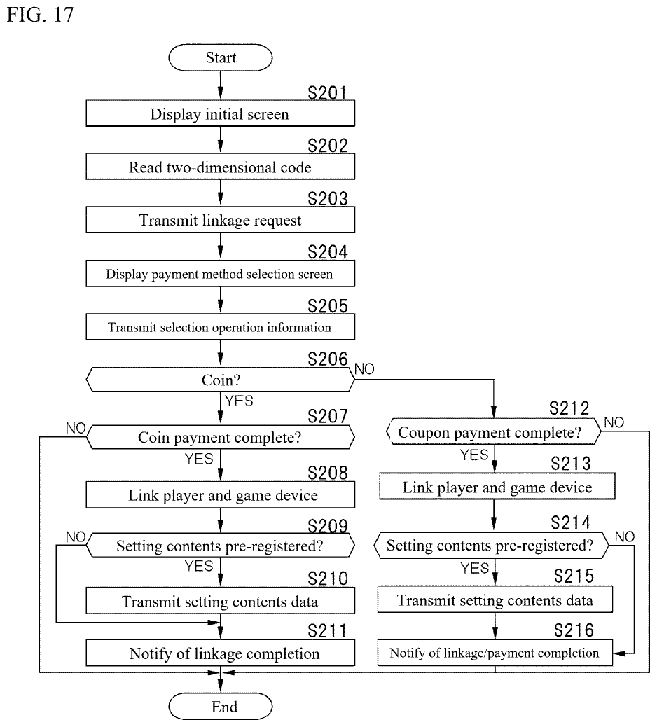

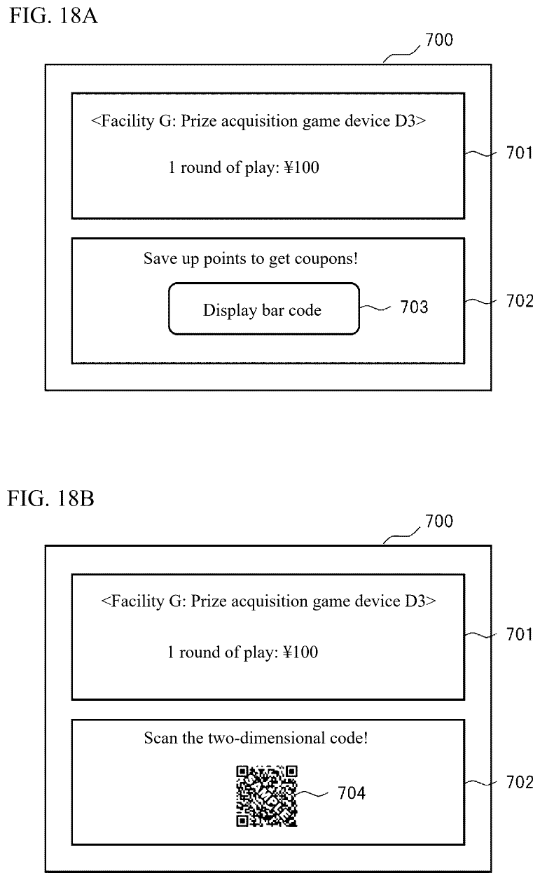

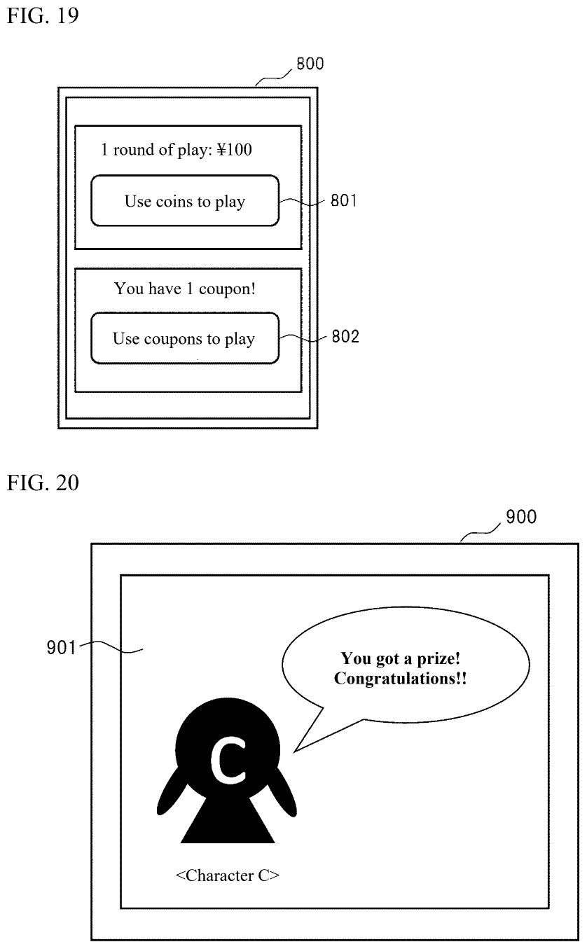

An operation example linking to the prize acquisition game device 50 according to one or more embodiments will be described using FIG. 17 to FIG. 19. FIG. 17 is a flowchart for describing an operation example relating to linking to the prize acquisition game device 50 according to one or more embodiments. FIG. 18A and FIG. 18B are visualization illustrating one example of an initial screen 700 in one or more embodiments. FIG. 19 is a visualization illustrating one example of a payment method selection screen 800 in one or more embodiments.

As illustrated in FIG. 17, first of all, when the player performs a predetermined touch operation using the setting operation unit 58, the code generation unit 512 of the prize acquisition game device 50 generates a two-dimensional code (identification code) generated by encoding the most recent key code and game device ID transmitted from the server device 20 and causes the game device display unit 53 to display the initial screen 700, which includes the two-dimensional code (step S201).

Specifically, when the key generation unit 212 of a server device 20 generates a key code Q1 at a time T1, generates a key code Q2 at a time T2 after a predetermined time elapses, and generates a key code Q3 at a time T3 after a predetermined time elapses, the most recent key code Q3 transmitted from the server device 20 is stored in the game device memory unit 52 of the prize acquisition game device 50 after the time T3. Therefore, the code generation unit 512 of the prize acquisition game device 50 generates a two-dimensional code including the most recent key code Q3 at the time T3 or later and causes such to be displayed on the initial screen 700.

As illustrated in FIG. 18A, the initial screen 700 includes an information area 701 of the prize acquisition game device 50 and a link setting area 702 for linking to the prize acquisition game device 50. An operation button 703 is displayed in the link setting area 702. When the player selects the operation button 703 by a touch operation using the setting operation unit 58 in the initial screen 700 illustrated in FIG. 18A, a two-dimensional code 704 is displayed in the link setting area 702 as illustrated in FIG. 18B.

Next, when the player performs a predetermined touch operation using the player terminal operation unit 13 after starting the player software, the code scanning unit 14 of the player terminal 10 uses the camera function of the player terminal 10 to scanned an image of the two-dimensional code displayed on the game device display unit 53 and extracts the key code and game device ID (step S202).

Next, the game linkage unit 111 of the player terminal 10 transmits a link request between the player terminal 10 and the prize acquisition game device 50 to the server device 20 via the network, together with the player ID, the key code extracted by the code scanning unit 14, and the game device ID (step S203).

Next, when the two-dimensional code 704 displayed on an initial screen 700 of the prize acquisition game device 50 is scanned by the code scanning unit 14 of the player terminal 10, the game linkage unit 111 of the player terminal 10 displays the payment method selection screen 800 on the player terminal display unit 15 (step S204).

The payment method selection screen 800 displays an operation button 801 for paying a price for playing with coins and an operation button 802 for paying the price for playing using a coupon, as illustrated in FIG. 19.

When the player selects the operation button 801 or the operation button 802 by a touch operation using the setting operation unit 58 on the payment method selection screen 800 illustrated in FIG. 19, the game linkage unit 111 of the player terminal 10 transmits selection operation information of the player together with the player ID to the server device 20 via the network (step S205).

Next, upon receiving the selection operation information of the player from the player terminal 10 having sent the collaboration request, when the player linkage unit 211 of the server device 20 determines whether payment of the price for playing will be made in coins or coupons based on the selection operation information of the player (step S206).

When it is determined that the player pays the price for playing with a coin (step S206: YES), the player linkage unit 211 of the server device 20 determines whether payment of the price for playing with coins has been completed in the prize acquisition game device 50 (step S207).

Specifically, when the coin insertion unit 59 of the prize acquisition game device 50 detects that a predetermined number of coins have been inserted into the insertion port as the price for one round of play, detection information thereof is transmitted to the server device 20 via the network, together with the game device ID. If the detection information is received from the prize acquisition game device 50 within a predetermined time, the player linkage unit 211 of the server device 20 determines that payment of the price for playing with coins has been completed in the prize acquisition game device 50.

In contrast to this, if the detection information is not received from the prize acquisition game device 50 within the predetermined time, the player linkage unit 211 of the server device 20 determines that payment of the price for playing with coins has still not been completed in the prize acquisition game device 50.

Next, if it is determined that payment of the price for playing using a coin has not been completed (step S207: NO), the player linkage unit 211 of the server device 20 ends the processing of this flowchart. In contrast to this, if it is determined that the payment of the price for playing by the coin has been completed (step S207: YES), the player terminal 10 having scanned the two-dimensional code of the prize acquisition game device 50 and the prize acquisition game device 50 are associated and paired to link the player and the prize acquisition game device 50 (step S208).

Specifically, the player linkage unit 211 of the server device 20 references to facility information illustrated in FIG. 6 and game device information illustrated in FIG. 7 and uses the game device ID of a prize acquisition game device 50 whose two-dimensional code was scanned by the player terminal 10 to specify player linkage information corresponding to the prize acquisition game device 50. Then, as illustrated in FIG. 8, the player ID of the player terminal 10 having scanned the two-dimensional code of the prize acquisition game device 50 and the game device ID of the prize acquisition game device 50 are associate, and pairing is registered in the player linkage information. Thus, it is possible to identify the linked player of the prize acquisition game device 50 at the present time.

In one or more embodiments, when a link request is transmitted again from a player (a player terminal 10) already linked by pairing registration, or a link request is transmitted from another player (another player terminal 10) for a prize acquisition game device 50 already linked by pairing registration the player linkage unit 211 of the server device 20 rejects linkage without performing new pairing registration.

That is, when the player linkage unit 211 of the server device 20 is accessed by a plurality of player terminals 10 having scanned the two-dimensional code of the prize acquisition game device 50, the prize acquisition game device 50 and one player terminal 10 out of the plurality of player terminals 10 are linked one to one.

Next, the player linkage unit 211 of the server device 20 references the player setting information set in the player information illustrated in FIG. 4, determines whether the setting contents relating to the prize acquisition game device 50 (that is, any one of the four types of setting contents) determined by the player linked through pairing registration have been pre-registered (step S209).

If the player linkage unit 211 of the server device 20 determines that none of the setting contents (any one type) relating to the prize acquisition game device 50 determined by the player are registered (step S209: NO), the processing proceeds to a step S211 to be described later. In contrast to this, if it is determined that the setting contents (any one type) relating to the prize acquisition game device 50 determined by the player are registered (step S209: YES), data indicating the type of the pre-registered setting contents is transmitted to the prize acquisition game device 50 to which the player is linked (step S210). Then, the setting storage unit 514 of the linked prize acquisition game device 50 stores the data received from the server device 20 in the game device storage unit 52 as player setting information.

Next, the player linkage unit 211 of the server device 20 notifies of completion of linkage between the player terminal 10 and the prize acquisition game device 50 in the player terminal display unit 15 of the player terminal 10 (step S211). Then, the player linked by the pairing registration performs gameplay on the prize acquisition game device 50.

Conversely, when it is determined that the player pays the price for playing with a coupon (step S206: NO), the player linkage unit 211 of the server device 20 determines whether payment of the price for playing using a coupon has been completed (step S212).

Specifically, the player linkage unit 211 of the server device 20 references the player information illustrated in FIG. 4, and reduces a quantity of coupons owned by the player by one round of play to determine that the payment of the price for playing using a coupon has completed.

In contrast to this, the player linkage unit 211 of the server device 20 references the player information illustrated in FIG. 4 and, when the quantity of coupons possessed by the player is less than the quantity of one round of play and is insufficient, determines that payment of a price for playing using the coupons has not yet been completed.

Next, if it is determined that payment of the price for playing using a coupon has not been completed (step S212: NO), the player linkage unit 211 of the server device 20 ends the processing of this flowchart. In contrast to this, if it is determined that the payment of the price for playing using a coupon has been completed (step S2 12: YES), the player of the player terminal 10 having scanned the two-dimensional code of the prize acquisition game device 50 and the prize acquisition game device 50 are associated and paired in the same manner as the process of step S208 described above, thereby linking to the prize acquisition game device 50 (step S213).

Next, once the linkage between the player and the prize acquisition game device 50 has been completed, similarly to step S209 described above, the player linkage unit 211 of the server device 20 determines whether the setting contents relating to the prize acquisition game device 50 (that is, any one of the four types of setting contents) determined by the player linked through pairing registration have been pre-registered (step S214).

If the player linkage unit 211 of the server device 20 determines that none of the setting contents (any one type) relating to the prize acquisition game device 50 determined by the player are registered (step S214: NO), the processing proceeds to a step S216 to be described later. In contrast to this, if it is determined that the setting contents (any one type) relating to the prize acquisition game device 50 determined by the player are not registered (step S214: YES), data indicating the type of the pre-registered setting contents is transmitted to the prize acquisition game device 50 to which the player is linked (step S215). Then, the setting storage unit 514 of the linked prize acquisition game device 50 stores the data received from the server device 20 in the game device memory unit 52 as player setting information.

Next, the player linkage unit 211 of the server device 20 notifies of completion of linkage between the player and the prize acquisition game device 50 and completion of coupon payment, in the player terminal display unit 15 of the player terminal 10 (step S216). Then, the player linked by the pairing registration performs gameplay on the prize acquisition game device 50.

### <Reflection of Setting Contents Determined by Player>

operation examples relating to reflection of setting contents decided by the player, according to one or more embodiments, will be described using FIG. 20. FIG. 20 is a visualization illustrating one example of a spectacle screen 900 in one or more embodiments. Below, an operation example of an operation relating to reflection of an “image,” which is one example of setting contents, an operation example relating to reflection of “audio,” which is one example of setting contents, an operation example relating to reflection of an “arm operation,” which is one example of setting contents, and an operation example relating to reflection of “electric lighting” which is one example of setting contents.

### <Reflection of Cut-In Image>

The prize acquisition game control unit 511 of the linked prize acquisition game device 50 specifies setting contents (that is, a type of setting contents registered in advance) relating to the prize acquisition game device 50 determined by the linked player and acquired from a server device 20 by referencing player setting information stored in the game device memory unit 52.

Then, the prize acquisition game control unit 511 references the setting type information illustrated in FIG. 11, acquires the setting contents of the “image” included in the setting contents of the specified type, and reflects the acquired setting content of the “image” in the image to be displayed on the game device display unit 53 at any timing that does not interfere with the prize acquisition game played by the linked player.

Specifically, when the setting contents (that is, the type of the setting contents registered in advance) relating to the prize acquisition game device 50 determined by the linked player are “type C,” the prize acquisition game control unit 511 references the setting type information illustrated in FIG. 11 to acquire a “cut-in image C” in which a “character C” associated with a “type C” appears. Then, at a timing when the linked player is not operating the game operation unit 57, for example, at a timing when it is detected that the prize acquired by the prize acquisition unit 55 has fallen from the discharge port disposed in the prize housing unit 73, the prize acquisition game control unit 511 causes the game device display unit 53 to display a spectacle screen 900 that reflects a “cut-in image C” 901 in which the “character C” appears, as illustrated in FIG. 20.

The “any timing that does not interfere with the prize acquisition game played by the player” is, for example, a timing at which the player is not operating the game operation unit 57. When the player is operating the game operation unit 57, the prize acquisition unit 55 moves within the prize housing unit 73 according to the operation, and the player's sight is intently directed at the desired prize, and thus it can be said that this is a timing that interferes with the prize acquisition game played by the player. However, for example, when the arms 55a of the prize acquisition unit 55 perform a closing operation to grab a prize, when the arms 55a of the prize acquisition unit 55 performs an opening operation to release the grabbed prize, or when it is detected that a prize acquired by the prize acquisition unit 55 has fallen from an outlet located in the prize housing unit 73, the player is not operating the game operation unit 57 (or the game operation input from the player is not being accepted), and the player can direct their gaze toward the cut-in image, and this it can be said that this is a timing that does not interfere with the prize acquisition game played by the player.

### <Reflection of Voiceover>

The prize acquisition game control unit 511 of the linked prize acquisition game device 50 specifies setting contents (that is, a type of setting contents registered in advance) relating to the prize acquisition game device 50 determined by the linked player and acquired from a server device 20 by referencing player setting information stored in the game device memory unit 52.

Then, the prize acquisition game control unit 511 references the setting type information illustrated in FIG. 11, acquires the “audio” setting contents included in the setting contents of the identified type, and reflects the acquired “audio” setting contents in audio output by the audio output unit 61 while the linked player is playing the prize acquisition game.

Specifically, when the setting contents (that is, the type of the setting contents registered in advance) relating to the prize acquisition game device 50 determined by the linked player are “type C,” the prize acquisition game control unit 511 references the setting type information illustrated in FIG. 11 to acquire a “voiceover C,” which is a line of “character C” associated with the “type C.” Then, the prize acquisition game control unit 511 outputs the “voiceover C,” which is a line of the “character C,” to the audio output unit 61 while the linked player operates the game operation unit 57 to play the prize acquisition game.

In the case of “audio,” unlike the case of “image,” such is not limited to “any timing that does not interfere with the prize acquisition game,” and the setting contents relating to “audio” may be reflected at any timing during the prize acquisition game. This is because the player who is engrossed in playing the prize acquisition game can listen to the audio without hindrance to play even when the player's sight is intently directed toward the desired prize.

Furthermore, in addition to referencing the setting type information illustrated in FIG. 11, acquiring the setting contents of the “audio” and “image” included in the setting contents of the specified type, and reflecting the acquired setting content of the “image” in the image to be displayed on the game device display unit 53 at any timing that does not interfere with the prize acquisition game played by the linked player, the prize acquisition game control unit 511 can also reflect the acquired “audio” setting contents in the audio output by the audio output unit 61 at any timing during the prize acquisition game played by the linked player.

Specifically, when the setting contents (that is, the type of the setting contents registered in advance) relating to the prize acquisition game device 50 determined by the linked player are “type C,” in addition to referencing the setting type information illustrated in FIG. 11 to acquire a “cut-in image C” in which the “character C” associated with the “type C” appears, the prize acquisition game control unit 511 acquires the “voiceover C,” which is a line of the “character C” associated with the “type C.” Then, at a timing when the linked player is not operating the game operation unit 57, for example, at a timing when it is detected that the prize acquired by the prize acquisition unit 55 has fallen from the discharge port disposed in the prize housing unit 73 (that is, at a timing that does not interfere with the prize acquisition game played by the player), the prize acquisition game control unit 511, in addition to causing the game device display unit 53 to display a spectacle screen 900 that reflects a “cut-in image C” 901 in which the “character C” appears, as illustrated in FIG. 20, also causes the audio output unit 61 to output audio of “You got a prize! Congratulations!!” reflecting the “voiceover C,” which is a line of the “character C.”

For example, even at a timing when the player is operating the game operation unit 57 (that is, even at a timing that interferes with the prize acquisition game played by the player), the setting contents of “audio” can be reflected and the setting contents of “image” can be reflected. For example, while outputting the audio of “voiceover C,” which is a line of the “character C,” an animated image such as the “character C” lip-synced in the cut-in state is displayed. In such a case, the image can be displayed to an extent that causes substantially no interference with the prize acquisition game.

### <Reflection of Spectacle Operation>

The prize acquisition game control unit 511 of the linked prize acquisition game device 50 specifies setting contents (that is, a type of setting contents registered in advance) relating to the prize acquisition game device 50 determined by the linked player and acquired from a server device 20 by referencing player setting information stored in the game device memory unit 52.

Then, the prize acquisition game control unit 511 references the setting type information illustrated in FIG. 11 to acquire the setting contents of an “arm action” included in the setting contents of the specified type and reflects the acquired setting contents of the “arm action” in the opening and closing operation of the arms 55a performed by the prize acquisition unit 55 when play of the prize acquisition game by the linked player starts.

Specifically, when the setting contents (that is, the type of the setting contents registered in advance) relating to the prize acquisition game device 50 determined by the linked player are “type C,” the prize acquisition game control unit 511 references the setting type information illustrated in FIG. 11 to acquire a “spectacle operation C” associated with the “type C.” Then, when the linked player starts playing the prize acquisition game, the prize acquisition game control unit 511 controls the prize acquisition unit 55 so that the arms 55a open and close in an operation pattern according to the “spectacle operation C.”

Furthermore, in addition to referencing the setting type information illustrated in FIG. 11, acquiring the setting contents of the “arm operation” and “audio” included in the setting contents of the specified type, and reflecting the setting contents of the acquired “arm operation” in the opening and closing operation of the arms 55a to be performed by the prize acquisition unit 55 at the start of play of the prize acquisition game by the linked player, the prize acquisition game control unit 511 can also reflect the acquired “arm operation” setting contents in the audio output by the audio output unit 61 at any timing during the prize acquisition game played by the linked player.

Specifically, when the setting contents (that is, the type of the setting contents registered in advance) relating to the prize acquisition game device 50 determined by the linked player are “type C,” in addition to referencing the setting type information illustrated in FIG. 11 to acquire the “spectacle operation C” associated with the “type C” appears, the prize acquisition game control unit 511 acquires the “voiceover C,” which is a line of the “character C” associated with the “type C.” Then, when the linked player starts playing the prize acquisition game, in addition to controlling the prize acquisition unit 55 so that the arms 55a are opened and closed by an operation pattern according to the “spectacle operation C,” the prize acquisition game control unit 511 causes the audio output unit 61 to output audio of “Try to get the prize!!” reflecting the “voiceover C,” which is a line of the “character C .”

### <Reflection of Light Emitting Operation>

The prize acquisition game control unit 511 of the linked prize acquisition game device 50 specifies setting contents (that is, a type of setting contents registered in advance) relating to the prize acquisition game device 50 determined by the linked player and acquired from a server device 20 by referencing player setting information stored in the game device memory unit 52.

Then, the prize acquisition game control unit 511 references the setting type information illustrated in FIG. 11, acquires the “electric lighting” setting contents included in the setting contents of the identified type, and reflects the acquired “electric lighting” setting contents in a light emission color and light emission pattern emitted by the light emission unit when starting play of the prize acquisition game by the linked player.

Specifically, when the setting contents (that is, the type of the setting contents registered in advance) relating to the prize acquisition game device 50 determined by the linked player are “type C,” the prize acquisition game control unit 511 references the setting type information illustrated in FIG. 11 to acquire a “light emission color C” matching an image color of the “character C” associated with the “type C,” and a “light emission operation C.” Then, when the linked player starts playing the prize acquisition game, the prize acquisition game control unit 511 controls the light emission unit 60 to emit light according to a light emission pattern following the “light emission operation C” in the “light emission color C” matching the image color of the “character C.”

Furthermore, in addition to referencing the setting type information illustrated in FIG. 11, acquiring the setting contents of the “electric lighting” and “audio” included in the setting contents of the specified type, and reflecting the setting contents of the acquired “electric lighting” in the light emission color and light emission pattern emitted by the light emission unit 60 at the start of play of the prize acquisition game by the linked player, the prize acquisition game control unit 511 can also reflect the acquired “audio” setting contents in the audio output by the audio output unit 61 at any timing during the prize acquisition game played by the linked player.

Specifically, when the setting contents (that is, the type of the setting contents registered in advance) relating to the prize acquisition game device 50 determined by the linked player are “type C,” in addition to referencing the setting type information illustrated in FIG. 11 to acquire the “light emission color C” matching the image color of the “character C” associated with the “type C,” and the “light emission pattern C,” the prize acquisition game control unit 511 acquires the “voiceover C,” which is a line of the “character C” associated with the “type C.” Then, when the linked player starts playing the prize acquisition game, in addition to controlling the light emission unit 60 to emit light according to the light emission pattern following the “light emission operation C” in the “light emission color” matching the image color of the “character C ,” the prize acquisition game control unit 511 causes the audio output unit 61 to output audio of “Try to get the prize!!” reflecting the “voiceover C,” which is a line of the “character C.”

<Unlinking from Prize Acquisition Game Device 50>

After the prize acquisition game ends, when the player selects a cancel button displayed on the game device display unit 53 by touching the setting operation unit 58, the prize acquisition game control unit 511 sends a request to unlink the player and the prize acquisition game device 50, along with the game device ID, to the server device 20 via the network.

Note that the unlink request may be transmitted to the server device 20 on the condition such as that the payment of the unit price of play is not made until a predetermined time has elapsed after the end of the prize acquisition game.

Furthermore, when the player selects the cancel button displayed on the game device display unit 53 by touching the setting operation unit 58, the prize acquisition game control unit 511 deletes from the game device memory unit 52 data indicating the type of setting content that was saved as the player setting information of that player. Thus, the setting contents of the player are not reflected in the linked prize acquisition game device 50.

Note that the configuration may be such that, until the predetermined time elapses from the end of the prize acquisition game, the setting contents are no longer reflected on conditions such as that the payment of the play unit price was not made.

Next, upon receiving the unlink request from the prize acquisition game device 50, the player linkage unit 211 of the server device 20 clears the pairing registration between the linked player and the prize acquisition game device 50.

Specifically, the player linkage unit 211 of the server device 20 references to facility information illustrated in FIG. 6 and game device information illustrated in FIG. 7 and uses the game device ID of the prize acquisition game device 50 on which the cancel button was pressed to specify player linkage information corresponding to the prize acquisition game device 50. Then, the pairing registration between the linked player and the prize acquisition game device 50 is deleted from the specified player linkage information.

### Other Embodiments

The above embodiments are provided to facilitate understanding of the present invention and is not to be construed as limiting the present invention. The present invention may be modified or improved without departing from the spirit thereof, and the present invention also includes equivalents thereof. In particular, the embodiments described below are also included in the present invention. That is, the present invention may be configured by appropriately combining the embodiments described above with the embodiments described below.

### <Spectacle Operation>

In the embodiments described above, a spectacle operation was described by using the case of an opening and closing operation of the arms 55a as an example, but the present invention is not limited thereto. For example, this may be a movement operation of the moving unit 56, or the opening and closing operation of the arms 55a may be combined with the movement operation of the moving unit 56.

Specifically, after the moving unit 56 moves the prize acquisition unit 55 with the arms 55a in an “open” state downward and downward in the vertical direction, then stops such after returning slightly upward in the vertical direction, causing the prize acquisition unit 55 to operate so that the arms 55a alternate between the “open” state and the “closed” state. Thus, when the character corresponding to the setting type is a “power type character,” it is possible to express a powerful movement such as a sumo wrestler stomping.

As another operation pattern, the moving unit 56 moves the prize acquisition unit 55 from the initial position in the left-right direction to the final position at a high speed and then moves the prize acquisition unit 55 downward in the vertical direction, while operating such so as to return to the initial position in the left-right direction. Thus, when the character corresponding to the setting type is a “speed type character,” it is possible to express an operation of moving at high speed.

As another operation pattern, after moving the prize acquisition unit 55 from the initial position in the vertical direction to the lowest position, the moving unit 56, while randomly moving the prize acquisition unit 55 in the horizontal directions in a low position as is, causes the prize acquisition unit 55 to operate so as to repeat the “open” state and the “closed” state of the arms 55a. Thus, when the character is an “active type character,” it is possible to vigorously express a lively motion.

As another operation pattern, the moving unit 56 moves the prize acquisition unit 55 so as to rotate in the horizontal directions or to move in a circular motion, while operating such that the prize acquisition unit 55 is rotates or the arms 55a open and close. Thus, when the character is a “dance type character,” it is possible to express movement of dancing while turning smoothly.

### <Relationship Between Setting Contents of Player and Setting Contents of Administrator>

In the embodiment described above, the administrator can determine setting contents relating to the prize acquisition game device 50 by using the prize acquisition game device 50, and the player can determine setting contents relating to the prize acquisition game device 50 by using the player terminal 10. As a result, the setting contents determined by the administrator and the setting contents determined by the player would overlap.

Therefore, when there is such an overlap of setting contents, for example, setting contents determined by the player take precedence. More specifically, when the administrator sets the light emission color emitted by the light emission unit 60 to “white” for the purpose of attracting customers and the light emission color emitted by the light emission unit 60 to “green,” which is the image color of the “character C” due to the player selecting “type C (character C)” as the setting type, during play of the player, the setting contents of the player are given priority, and the light emission unit 60 performs control so as to change the light emission color to “green” and then emit light.

Alternatively, the setting contents determined by the administrator may prioritized. Specifically, when the administrator sets the light emission color emitted by the light emission unit 60 at the time of notification of an error to “red” and sets the light emission color emitted by the light emission unit 60 to “blue,” which is an image color of a “character A” due to the player selecting “type A (character A)” as the setting type, the setting contents of the administrator may be prioritized when an error occurs while the light emission unit 60 is emitting in “blue,” which is the image color of the “character A” according to the setting contents of the player, and the light emission unit 60 may be controlled to change the light emission color to “red” and then emit light.

### <Character>

In the embodiments described above, the setting contents are classified into a plurality of types, and cases in which characters are associated by type were used as an example for description, but it is not necessary to associate characters, and it is only necessary that each of the setting contents can be distinguished as a setting type.

Furthermore, in the embodiments describe above, an example was described in which, in a case in which the setting contents are classified into a plurality of types, among the plurality of types, a type (setting type ID) that the player is permitted to use is registered as the availability information, but the present invention is not limited to this. For example, among characters associated with a plurality of types, characters (character IDs) that the player is permitted to use may be registered as availability information. In this case, among the characters whose use is permitted to the player by the availability information, one character (character ID) selected by the player by operating the player terminal 10 may be registered as player setting information.

Furthermore, in the embodiments described above, an example was described in which the player setting information stored in the game device memory unit 52 is the player setting information acquired from the server device 20 and information indicating the setting contents of the prize acquisition game device 50 determined by the operation of the player, and
setting contents are the setting type ID of the type selected by the player is explained by taking the case as an example, but the present invention is not limited to this. For example, the setting contents may be the character ID of the character selected by the player.

### <Linkage of Player Terminal 10 and Prize Acquisition Game Device 50>

In the embodiments described above, an example was described in which, when the player pays the price for playing with coins, the player linkage unit 211 of the server device 20 links the player and the prize acquisition game device 50 by pairing the player terminal 10 having scanned the two-dimensional code of the prize acquisition game device 50 and the prize acquisition game device 50 by associating them with each other on the condition that payment of the price for playing with coins is completed, but the present invention is not limited to this. For example, when it is determined that the player pays the price for playing with coins (step S206: YES), the player linkage unit 211 of the server device 20 can also link the player and the prize acquisition game device 50 before the payment of the price for playing with coins is completed.

Furthermore, in the embodiments described above, an example was described in which, when the player pays the price for playing with a coupon, the player linkage unit 211 of the server device 20 links the player and the prize acquisition game device 50 by pairing the player terminal 10 having scanned the two-dimensional code of the prize acquisition game device 50 and the prize acquisition game device 50 by associating them with each other on the condition that payment of the price for playing with a coupon is completed, but the present invention is not limited to this. For example, when it is determined that the player pays the price for playing with a coupon (step S206: NO), the player linkage unit 211 of the server device 20 can also link the player and the prize acquisition game device 50 before the payment of the price for playing with coins is completed.

### <Payment of Price for Playing>

In the above embodiments, an example was described in which the player is made to select either coins or coupons as a payment method on the payment method selection screen 800 of the player terminal 10, but the present invention is not limited to this. For example, it is possible to allow a player to perform a payment operation on a screen of the player terminal 10 only when the player pays the price for playing using the coupon. In the case of paying the price for playing with coins, it is possible to configure such that, even when the player does not perform an operation on the screen of the player terminal 10 in advance and simply inserts the coin into the prize acquisition game device 50, a notification that a coin was inserted is transmitted from the player 50 to the server device 20.

### <Generation of Two-Dimensional Code>

In the embodiments described above, an example was described in which the prize acquisition game device 50 generates a two-dimensional code (identification code), but the present invention is not limited to this. For example, the server device 20 may generate a two-dimensional code. In this case, the server device 20 generates an image of a two-dimensional code including a most recent key code and a game machine ID and transmits such to the prize acquisition game device 50. The prize acquisition game device 50 causes the game device display unit 53 to display the two-dimensional code transmitted from the server device 20.

### <Identification Code>

In the embodiments described above, the identification code is not limited to a QR code (registered trademark) acting as one example of a two-dimensional code. For example, a maxi code, a berry code, a data matrix code, a bar code, or the like may be used.

### <Prizes>

In the above embodiments, the prizes housed in the prize acquisition game device 50 are not limited to items that the player can directly acquire (for example, stuffed toys or the like), but also include items that are stored as targets for acquisition in the game and can be exchanged for other prizes after acquisition and items that are not themselves provided but are used to compete for points or rankings.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

1 Game system
10 Player terminal
11 Player terminal control unit
12 Player terminal memory unit
13 Player terminal operation unit
14 Code scanning unit
15 Player terminal display unit
16 Player terminal communication unit
20 Server device
21 Server device control unit
22 Server device memory unit
23 Server device input unit
24 Server device display unit
25 Server device communication unit
50 Prize acquisition game device
51 Game device control unit
52 game device memory unit
53 Game device display unit
54 Game device communication unit
55 Prize acquisition unit
55a Arm
56 Moving unit
57 Game operation unit
58 Setting operation unit
59 Coin insertion unit
60 Light emission unit
61 Audio output unit
73 Prize housing unit
74 Prize presentation unit
75 Prize retrieval port
111 Game linkage unit
112 Display control unit
211 Player linkage unit
212 Key generation unit
213 Setting contents registration unit
511 Prize acquisition game control unit
512 Code generation unit
513 Payment management unit
514 Setting storage unit
500 Setting screen
600 Setting screen
601 Character placement area
602 Select button
650 Setting screen
651 Character
652 Registration button
700 Initial screen
701 Information area
702 Linkage setting area
703 Operation button
704 Two-dimensional code
800 Payment method selection screen
801 Operation button
802 Operation button
900 Spectacle screen
901 Cut-in image

What is claimed is:

1. A game system, comprising:
a player terminal operated by a player;
a prize acquisition game device that comprises a prize catcher equipped with an arm, inside a prize housing that houses a prize for a prize acquisition game; and
a server device that communicates with the player terminal and the prize acquisition game device via a network, wherein
the server device comprises a central processing unit (CPU) that:
in response to a request from the player terminal, registers, in association with the player, a setting content that relates to the prize acquisition game device and has been determined by an operation of the player, and
in response to a request from the player terminal, links the player to the prize acquisition game device on which the player plays the prize acquisition game, and
the prize acquisition game device comprises a central processing unit (CPU) that:
obtains, from the server device, the setting content registered in association with the linked player, and
advances the prize acquisition game played by the player by reflecting the setting content in the prize acquisition game.

2. The game system according to claim 1, wherein
the prize acquisition game device further comprises:
a display device that displays an image,
the setting content registered in association with the player includes a setting content relating to the image, and
the CPU of the prize acquisition game device reflects the setting content relating to the image at any timing that does not interfere with the prize acquisition game played by the player.

3. The game system according to claim 1, wherein
the prize acquisition game device further comprises:
an audio output device that outputs audio,
the setting content registered in association with the player includes a setting content relating to the audio, and
the CPU of the prize acquisition game device reflects the setting content relating to the audio at any timing during the prize acquisition game by the player.

4. The game system according to claim 1, wherein
the setting content registered in association with the player includes a setting content relating to an opening and closing operation of the arm, and
the CPU of the prize acquisition game device reflects the setting content relating to the opening and closing operation of the arm in the opening and closing operation of the arm performed by the prize catcher at a time when the player starts playing the prize acquisition game.

5. The game system according to claim 1, wherein
the CPU of the server device registers, in association with the player, a setting content associated with a character selected by an operation of the player from among a plurality of types of characters each associated with the setting content of the prize acquisition game device, and
the CPU of the prize acquisition game device acquires from the server device the setting content associated with the character registered in association with the linked player, and advances the prize acquisition game played by the player by reflecting the setting content in the prize acquisition game.

6. The game system according to claim 5, wherein
the setting content associated with each of the types of characters is different for each character and includes at least a setting content relating to an image associated with each character and a setting content relating to audio associated with each character,
the prize acquisition game device further comprises:
a display device that displays an image; and
an audio output device that outputs audio, and
the CPU of the prize acquisition game device acquires from the server device the setting content associated with the character registered in association with the linked player, reflects the setting content relating to the image associated with the character in the image displayed by the display device at any timing that does not interfere with the prize acquisition game played by the player, and reflects the setting content relating to the audio associated with the character in the audio output by the audio output device at any timing during the prize acquisition game by the player.

7. A prize acquisition game device that communicates via a network with a server device that can be accessed by a player terminal operated by the player, the prize acquisition game device comprising:
a prize catcher equipped with an arm, inside a prize housing that houses a prize for a prize acquisition game; and
a central processing unit (CPU), wherein
the server device:
registers, in response to a request from the player terminal, a setting content that relates to the prize acquisition game device and has been determined by the player, in association with the player, and
links, in response to a request from the player terminal, the player with the prize acquisition game device on which the player plays the prize acquisition game, and
the CPU of the prize acquisition game device acquires the setting content registered in association with the linked player from the server device, and advances the prize acquisition game played by the player by reflecting the setting content in the prize acquisition game.
